(19) United States
(12) Patent Application Publication
(10) Pub. No.: US 2022/0366420 A1
(43) Pub. Date: Nov. 17, 2022

(54) ROLLOVER FRAUD AVOIDANCE

(71) Applicant: Wells Fargo Bank, N.A., San Francisco, CA (US)

(72) Inventors: Pooja Kumari, Hyderabad (IN); Roshini Gupta Perumalla, Hyderabad (IN)

(21) Appl. No.: 16/367,931

(22) Filed: Mar. 28, 2019

(51) Int. Cl. G06Q 20/40; G06Q 40/06

(52) U.S. Cl. CPC G06Q 20/4016; G06Q 40/06

(57) ABSTRACT

Fraud associated with rollover of funds is avoided with enhanced mechanisms. Employee status can be determined from an employee profile. Based on changes to the employee profile, for example reflecting a change to the status of an employee, actions can be triggered to safe guard and aid rollover of an eligible retirement account. In one instance, notifications reminding an employee to initiate rollover of a retirement account of the employee can be generated, scheduled, and delivered in accordance with a notification plan. Further, a rollover grievance request from an employee can be processed with respect to a former employer, for instance by way of various notifications and optionally escalating further processing to an external party.

### BACKGROUND

Instances of fraud and account takeover are increasing across the financial industry. Avoidance of fraudulent activities in banking is a great challenge. Particularly challenging is reducing fraud while performing rollover of funds from a retirement account after retirement or departure of an employee from an organization. Defined-contribution plans, such as a 401(k) account, allow an employee to make contributions from a paycheck depending on the options offered by a particular plan. A defined-contribution plan is intended as a retirement savings plan sponsored by an employer. Once retired, an employee can withdraw funds from a 401(k) account to fund retirement. If an employee decides to leave a current employer, the account could be rolled over into a 401(k) account of another employer. However, there could be instances of rollover fraud, and unauthorized rollover of funds from the 401(k) account may happen.

### SUMMARY

The following presents a simplified summary of the innovation in order to provide a basic understanding of some aspects of the innovation. This summary is not an extensive overview of the innovation. It is not intended to identify key/critical elements of the innovation or to delineate the scope of the innovation. Its sole purpose is to present some concepts of the innovation in a simplified form as a prelude to the more detailed description that is presented later.

The innovation disclosed and claimed herein, in one aspect thereof, comprises systems and methods of rollover fraud avoidance. A method includes determining a classification of an employee based on an employee profile. The method includes receiving authorization to receive notifications regarding a retirement account of the employee. The method includes generating a notification plan regarding the retirement account based on the determined classification of employee and the authorization. The method includes receiving a rollover grievance request from the employee including a rollover grievance. The method includes registering the rollover grievance against a previous employer of the employee.

A system of the innovation can include a classification component that determines a classification of an employee based on an employee profile residing on a profile component. An authorization component receives authorization to receive notifications regarding a retirement account of the employee. An execution component generates a notification plan regarding the retirement account based on the determined classification of employee and the authorization. A grievance manager receives a rollover grievance request from the employee including a rollover grievance. The grievance manager registers the rollover grievance against a previous employer of the employee.

A computer readable medium has instructions to control one or more processors. The instructions identify an employee status an employee based on an employee profile. The instructions determine the employee has a rollover-eligible retirement account from a previous employer. The instructions receive authorization to receive notifications regarding the retirement account of the employee. The instructions generate a notification plan regarding the retirement account based on the determined classification of employee and the authorization. The instructions receive a rollover grievance request from the employee including a rollover grievance. The instructions register the rollover grievance against a previous employer of the employee.

In aspects, the subject innovation provides substantial benefits in terms of rollover fraud avoidance. One advantage resides in a timely rollover of a balance from a lapsed or old retirement account. Another advantage resides in automating a grievance procedure when a previous employer has not fulfilled a rollover request. To the accomplishment of the foregoing and related ends, certain illustrative aspects of the innovation are described herein in connection with the following description and the annexed drawings. These aspects are indicative, however, of but a few of the various ways in which the principles of the innovation can be employed and the subject innovation is intended to include all such aspects and their equivalents. Other advantages and novel features of the innovation will become apparent from the following detailed description of the innovation when considered in conjunction with the drawings.

### BRIEF DESCRIPTION OF THE DRAWINGS

Aspects of the disclosure are understood from the following detailed description when read with the accompanying drawings. It will be appreciated that elements, structures, etc. of the drawings are not necessarily drawn to scale. Accordingly, the dimensions of the same may be arbitrarily increased or reduced for clarity of discussion, for example.

FIG. 1 illustrates an example component diagram of a system of the present innovation.

FIG. 2 illustrates an example component diagram of a classification component.

FIG. 3 illustrates an example component diagram of an execution component.

FIG. 4 illustrates a method for rollover fraud avoidance.

FIG. 5 illustrates an example method for rollover reminder assistance.

FIG. 6 illustrates an example method for rollover grievance assistance.

FIG. 7 illustrates a computer-readable medium or computer-readable device comprising processor-executable instructions configured to embody one or more of the provisions set forth herein, according to some embodiments.

FIG. 8 illustrates a computing environment where one or more of the provisions set forth herein can be implemented, according to some embodiments.

### DETAILED DESCRIPTION

Details below generally pertain to rollover fraud avoidance. Defined-contribution plans, such as 401(k) and 403(b) or other employer-sponsored retirement plans, are subject to fraud including unauthorized rollover of funds. To prevent fraud as well as facilitate safe rollover of funds, retirement accounts are subject to enhanced protection. In accordance with one aspect, an employee profile can be generated, stored, and maintained in an electronic repository. The employee profile can include information such as start date, previous employer, and/or retirement plan details, among other things. Based on changes to the employee profile, for example, reflecting changes to the status of an employee, actions can be triggered to safe guard and aid rollover of funds. In accordance with one aspect, the alerting can be employed to ensure timely rollover after a change of employee status. Further, automated assistance can be provided to prompt and facilitate rollover of funds by an employer in accordance with best practices designed to prevent rollover fraud. In one instance, grievance assistance can be provided with respect to a previous employer including various notifications and optionally escalating an unsolved issue to an external party.

Various aspects of the subject disclosure are now described in more detail with reference to the annexed drawings, wherein like reference numerals are used to refer to like elements throughout. It should be understood, however, that the drawings and detailed description relating thereto are not intended to limit the claimed subject matter to the particular form disclosed. Rather, the intention is to cover all modifications, equivalents, and alternatives falling within the spirit and scope of the claimed subject matter.

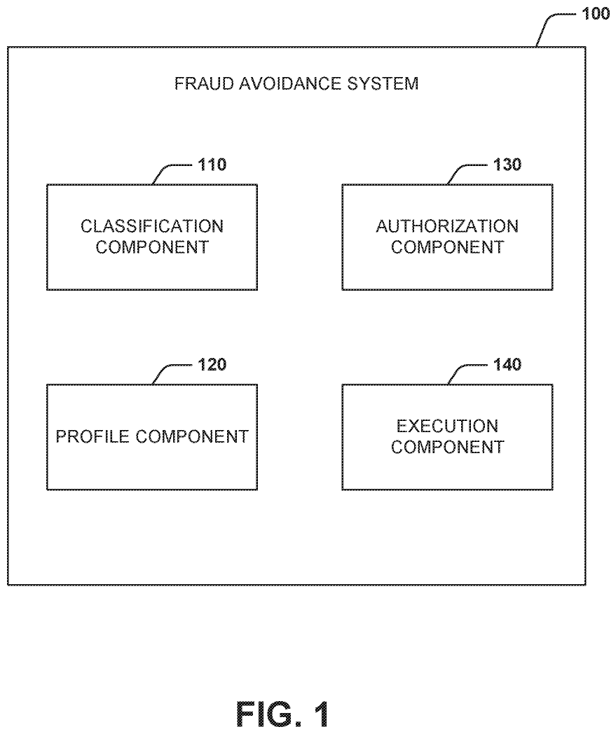

Referring initially to FIG. 1, a fraud avoidance system 100 for rollover is illustrated. The system 100 includes a classification component 110. The classification component 110 determines a classification of an employee based on an employee profile residing on a profile component 120. The classification component 110 identifies an employee status based on the employee profile. The classification component 110 parses an employee profile in the profile component 120 to determine a classification of the employee. In some embodiments, the employee profile can include a start date to facilitate the classification component 110 in determining whether the employee is a new employee or existing employee. In other embodiments, the employee profile can include a retirement date to facilitate the classification component 110 in determining whether the employee is a retired (or retiring) employee.

If the classification component 110 classifies the employee as a new employee or retired employee, the classification component 110 determines whether the employee has a rollover-eligible retirement account from a previous employer. In some embodiments, the classification component 110 can access an employee's financial data. In other embodiments, the classification component 110 requests and/or receives financial data from the employee such as account number, financial institution, and/or the like. In some embodiments, the classification component 110 can contact the previous employer of the employee to retrieve financial data regarding the retirement account.

The system 100 includes an authorization component 130. The authorization component 130 receives authorization to receive notifications regarding a new retirement account (or distribution account) of the employee. The authorization component 130 can receive authorization to generate and send notifications to third parties regarding a rollover of a retirement account. In some embodiments, the authorization component 130 can send a request to the employee to provide authorization. In other embodiments, the authorization component 130 can retrieve an authorization from the employee profile in the profile component 120.

The system 100 includes an execution component 140. The execution component 140 generates a notification plan regarding the retirement account. The notification plan is generated based on the determined classification of the employee and the authorization. The notification plan can dictate or determine when to generate and/or send notifications to the employee and/or a previous employer. In some embodiments, the execution component 140 generates at least one notification to the employee at a frequency determined by the notification plan. The execution component 140 sends the notification to the employee. In some embodiments, the notification includes a reminder to the employee to rollover a balance of the rollover-eligible retirement account with a previous employer of the employee to a current retirement account and/or distribution account. In some embodiments, the notification includes a clickable link that facilitates the rollover by automating a request for a rollover check to be mailed or electronic transfer to the current retirement account upon clicking.

In some embodiments, the execution component 140 can receive a rollover grievance request from the employee. The rollover grievance request can include a rollover grievance (e.g. late or failure to provide the rollover funds from the rollover-eligible retirement account). The execution component 140 registers the rollover grievance against a previous employer of the employee. In some embodiments, the execution component 140 generates and sends a grievance link to the new employee to register the grievance with the previous employer. The execution component 140 sends grievance information regarding the rollover grievance to the previous employer.

In some embodiments, the execution component 140 generates a grievance notification plan based on the registered grievance against the previous employer, financial institution, and/or the like associated with the rollover-eligible retirement account. The execution component 140 generates and sends notifications regarding the registered grievance to the previous employer at a frequency determined by the notification plan until the grievance is resolved or escalated.

In some embodiments, the execution component 140 can determine whether the grievance has been resolved or not. The execution component 140 can determine that the grievance is not resolved within a predetermined period determined by the notification plan. The execution component 140 can escalate the registered grievance for action according to the notification plan. For example, the notification plan can dictate that notifications are sent to the previous employer once a week for eight weeks until the grievance is resolved. If not resolved before the eighth notification or within a predetermined time after the eighth notification, the execution component 140 can escalate the grievance for action. In some embodiments, the execution component 140 forwards the grievance to an external agency to facilitate rollover of the rollover-eligible retirement account.

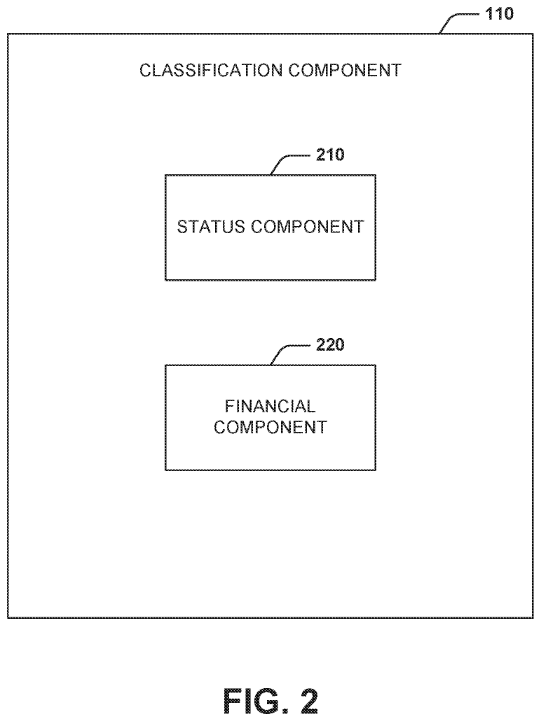

FIG. 2 illustrates a detailed component diagram of the classification component 110. The classification component 110 determines a classification of an employee based on an employee profile residing on a profile component 120. The classification component 110 includes a status component 210. The status component 210 identifies an employee status based on the employee profile. The status component 210 parses an employee profile in the profile component 120 to determine a classification of the employee. In some embodiments, the employee profile can include a start date to facilitate the status component 210 in determining whether the employee is a new employee or existing employee.

The classification component 110 includes a financial component 220. If the status component 210 classifies the employee as a new employee, the financial component 220 determines whether the employee has a rollover-eligible retirement account from a previous employer. In some embodiments, the financial component 220 can access an employee's financial data. In other embodiments, the financial component 220 requests and/or receives financial data from the employee such as account number, financial institution, and/or the like. In some embodiments, the financial component 220 can contact the previous employer of the employee to retrieve financial data regarding the rollover-eligible retirement account.

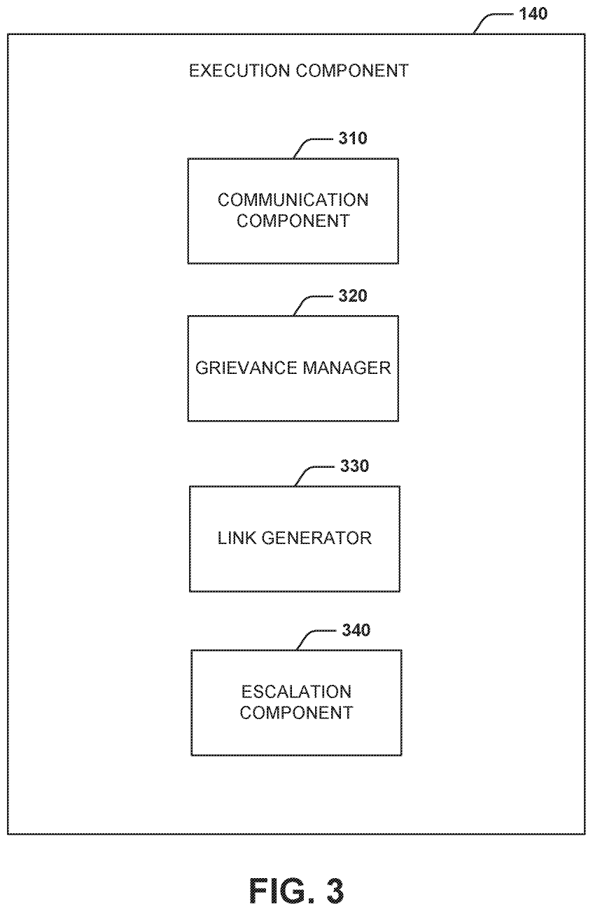

FIG. 3 illustrates a detailed component diagram of the execution component 140. The execution component 140 generates a notification plan regarding the retirement account. The notification plan is generated based on the determined classification of employee and the authorization. The notification plan can dictate or determine when to generate and/or send notifications to the employee.

The execution component 140 includes a communication component 310. In some embodiments, the communication component 310 generates at least one notification to the employee at a frequency determined by the notification plan. The communication component 310 sends the notification to the employee. In some embodiments, the notification includes a reminder to the employee to rollover a balance of the rollover-eligible retirement account with a previous employer of the employee to a current retirement account or equivalent. In some embodiments, the notification includes a clickable link that facilitates the rollover by automating a request for a rollover check to be mailed or electronic transfer to the current retirement account upon clicking. Notifications can also be customizable and correspond to an email, text message, phone call, voice message, and/or application specific alert, among other things.

In some embodiments, the execution component 140 includes a grievance manager 320. The grievance manager 320 can receive a rollover grievance request from the employee. The rollover grievance request can include a rollover grievance (e.g. late or failure to provide the rollover funds from the rollover-eligible retirement account). The grievance manager 320 registers the rollover grievance against a previous employer of the employee.

The execution component 140 includes a link generator 330. In some embodiments, the link generator 330 generates and sends a grievance link to the new employee to register the grievance with the previous employer. The grievance manager 320 sends grievance information regarding the rollover grievance to the previous employer.

In some embodiments, the grievance manager 320 generates a grievance notification plan based on the registered grievance against the previous employer, financial institution, and/or the like associated with the rollover-eligible retirement account. The communication component 310 and/or the grievance manager 320 generates and sends notifications regarding the registered grievance to the previous employer at a frequency determined by the notification plan until the grievance is resolved or escalated.

In some embodiments, the grievance manager 320 can determine whether the grievance has been resolved or not. The grievance manager 320 can determine that the grievance is not resolved within a predetermined period determined by the notification plan. The execution component 140 includes an escalation component 340. The escalation component 340 can escalate the registered grievance for action according to the notification plan. For example, the notification plan can dictate that notifications are sent to the previous employer once a week for eight weeks until the grievance is resolved. If not resolved before the eighth notification or within a predetermined time after the eighth notification, the escalation component 340 can escalate the grievance for action. In some embodiments, the escalation component 340 forwards the grievance to an external agency to facilitate rollover of the rollover-eligible retirement account.

The aforementioned system, environment, or the like has been described with respect to interactions between several components. It should be appreciated that such systems and components can include those components or sub-components specified therein, some of the specified components or sub-components, and/or additional components. Sub-components could also be implemented as components communicatively coupled to other components rather than included within parent components. Further yet, one or more components and/or sub-components may be combined into a single component to provide aggregate functionality. Communications between systems, components, and/or sub-components can be accomplished in accordance with either a push and/or pull model of control. The components may also interact with one or more other components not specifically described herein for the sake of brevity, but known by those of skill in the art. Furthermore, various portions of the disclosed systems above and methods below can include or employ of artificial intelligence, machine learning, or knowledge or rule-based components, sub-components, processes, means, methodologies, or mechanisms (e.g., support vector machines, neural networks, expert systems, Bayesian belief networks, fuzzy logic, data fusion engines, classifiers . . . ). Such components, inter alia, can automate certain mechanisms or processes performed thereby to make portions of the systems and methods more adaptive as well as efficient and intelligent. By way of example, and not limitation, the status component 210 can predict an upcoming status changed based on a variety of factors in an employee profile. Additionally, or alternatively, the grievance manager 320 can employ such functionality to learn and tailor grievance resolution strategies to particular employers or entities.

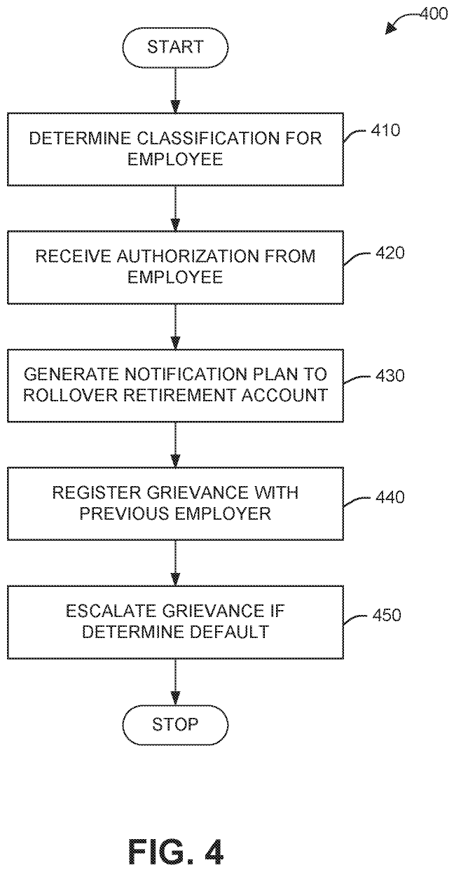

In view of the system 100 described above, methods that may be implemented in accordance with the disclosed subject matter will be better appreciated with reference to the flow charts of FIG. 4-6. While for purposes of simplicity of explanation, methods are shown and described as a series of blocks, it is to be understood and appreciated that the innovation is not limited by the order of the blocks as some blocks may occur in different orders and/or concurrently with other blocks, as some blocks from what is depicted and described herein. Moreover, not all illustrated blocks may be required to implement a method of the innovation. Further, each block can be implemented by computer program instructions that can be provided to a processor to produce a particular machine, such that the instructions executing on the processor create a means for implementing actions specified by a flow chart block.

With reference to FIG. 4, example method 400 is depicted for rollover fraud avoidance. At 410, a classification for an employee is determined. The classification can be an employee status, for example, a new employee. In some embodiments, the classification can be a new employee that has a rollover-eligible retirement account. At 420, authorization is received from the employee to receive notifications regarding retirement accounts. At 430, a notification plan is generated to rollover the eligible retirement account. At 440, a grievance can be registered against a previous employer if the previous employer has not rolled over the eligible retirement account. At 450, the grievance is escalated if the grievance has not been resolved in a predetermined amount of time.

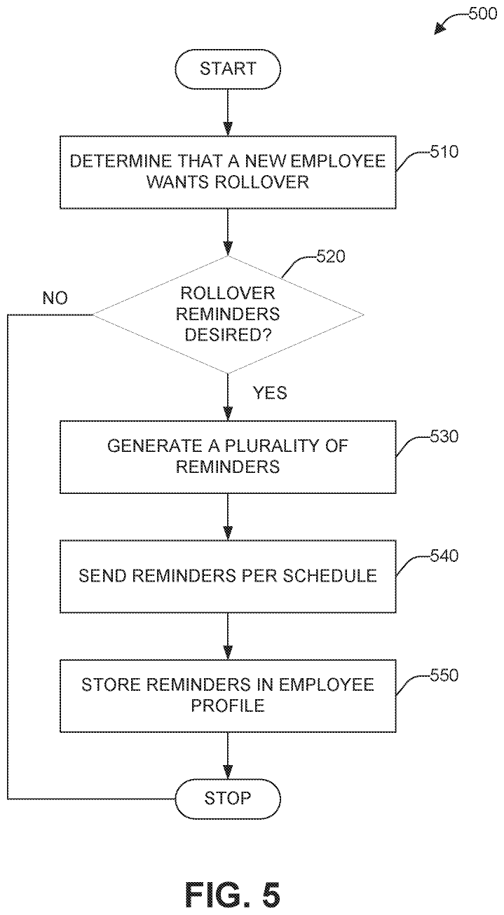

FIG. 5 illustrates an example method 500 of rollover reminder assistance. At 510, it is determined that a new employee wants to rollover an employer sponsored plan. In accordance with one particular embodiment, this determination can be made in conjunction with a response to a welcome email to a new employee. For instance, a welcome email can ask the new employee whether or not the employee has rolled over his/her 401(k) from a previous employer. At 520, a determination is made as to whether or not an employee desires rollover reminders associated with moving a rollover process forward. In one embodiment, the determination can be made by querying the employee, for instance by email or text message. If rollover reminders are not desired (“NO”), the method simply terminates. If rollover reminders are desired (“Yes”), the method proceeds to 530, where a plurality of reminders are generated. The reminders can be generated to be sent to the employee along a configurable schedule (e.g., monthly, weekly, bi-monthly . . . ). At 540, generated reminders are sent to the employee per a desired schedule. At 550, generated reminders are stored in the employee profile for later reference and processing.

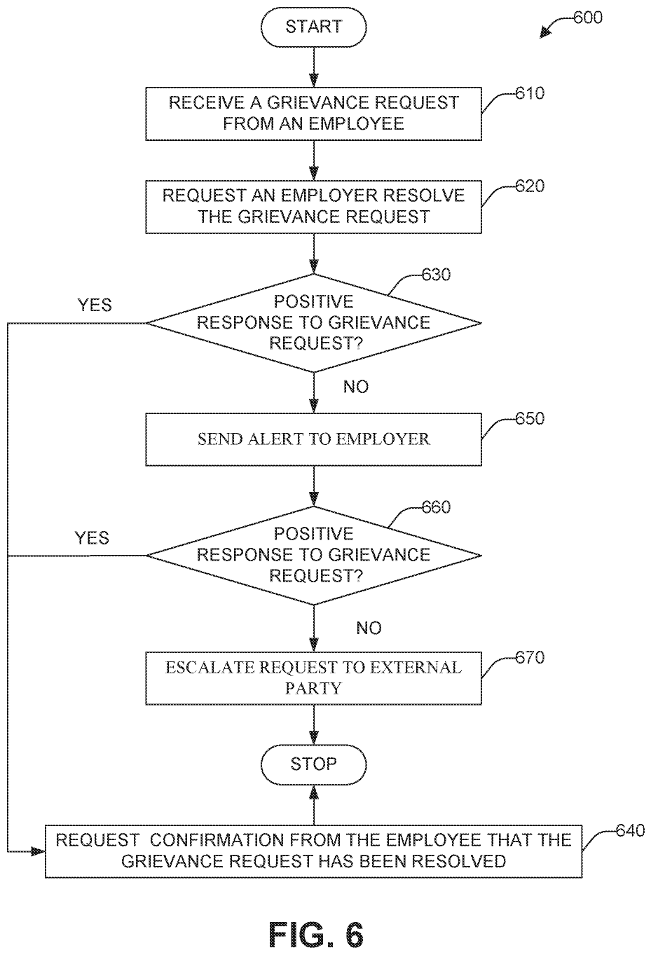

FIG. 6 illustrates an example method 600 of rollover grievance assistance. At 610, a grievance request is received from an employee. In one instance, a grievance request may be issued by an employee, if the employee had already requested a rollover action from his/her previous employer but has not received a response. At 620, a request is sent to the previous employer of the employee requesting that a grievance be resolved. Such a request can be submitted electronically by email or dedicated communication mechanism or by regular mail.

At 630, a determination is made as to whether a positive response to the grievance request has been received. For example, a positive response can indicate that a rollover will be initiated. If a positive response is received (“YES”), the method continues at 640, where confirmation is requested from the employee that the grievance request has been resolved. In other words, the employee is given the option to close, or opt out of, the grievance. If a positive response is not received at 630 (“NO”), the method proceeds to 650, where one or more alerts or reminders are sent to the employer to address the grievance. At 660, a determination is again made as to whether or not a positive response is received to the grievance request. If a positive response is received (“YES”), the method continues at 640, where confirmation is requested from the employee that the grievance has been resolved prior to terminating. If a positive response is not received (“NO”), the request is escalated to an external party, such as an external agency (e.g., ERISA), for further processing at 670.

Rollover grievance assistance has been described herein as a mechanism to remedy a failed attempt by an employee to have funds rolled over from an employer. However, rollover grievance assistance need not be utilized solely with respect to an aggrieved employee. Rather, the assistance can be employed as a first means to requesting rollover. In other words, rollover grievance assistance can be modified to be rollover assistance. In this context, the assistance can be enhanced to support decisions of an employee regarding rollover. There are many options for rollover of an eligible retirement account. For example, a 401(k) plan can be rolled over to an individual retirement account (IRA). Furthermore, there are tax implications and time limits for particular rollovers or distributions. Rollover assistance can involve educating employees on options and implications as well as aiding an employee in determining how to rollover funds. Further yet, rollover assistance can include performing a selected rollover or engaging another party to perform the rollover.

Rollover assistance can be integrated with previously disclosed systems and methods. In particular, instead of, or in addition to, querying an employee regarding receiving reminders or submitting a grievance request, the employee can be asked whether they would like assistance in rollover of an account. If they request assistance in this context, they can be provided with options and implications to guide construction of a rollover plan. Furthermore, the assistance can comprise effecting the rollover plan including contacting a previous employer and transferring funds as specified by a rollover plan.

As used in this application, the terms “component” and “system,” as well as various forms thereof (e.g., components, systems, sub-systems . . . ) are generally intended to refer to a computer-related entity, either hardware, a combination of hardware and software, software, or software in execution. For example, a component may be, but is not limited to being, a process running on a processor, a processor, an object, an executable, a thread of execution, a program, or a computer. By way of illustration, both an application running on a computer and the computer can be a component. One or more components may reside within a process or thread of execution, and a component may be localized on one computer or distributed between two or more computers.

The conjunction “or” as used in this description and appended claims is intended to mean an inclusive “or” rather than an exclusive “or,” unless otherwise specified or clear from context. In other words, “X” and “Y” is intended to mean any inclusive permutations of “X” and Y.” For example, if “‘A’ employs ‘X’,” “‘A’ employs ‘Y’,” or “‘A’ employs both ‘X’ and ‘Y’,” then “‘A’ employs ‘X’ or ‘Y’” is satisfied under any of the foregoing instances.

Further, to the extent the terms “includes,” “contains,” “has,” “having” or variations in form are thereof are used in either the detailed descriptions or the claims, such terms are intended to be inclusive in a manner similar to the term “comprising” as “comprising” is interpreted when employed as a transitional word in a claim.

Furthermore, the claimed subject matter can be implemented as a method, apparatus, or article of manufacture using standard programming or engineering techniques to produce software, firmware, hardware, or any combination thereof to control a computer to implement the disclosed innovation. Of course, many modifications may be made to this configuration without departing from the scope or spirit of the claimed subject matter.

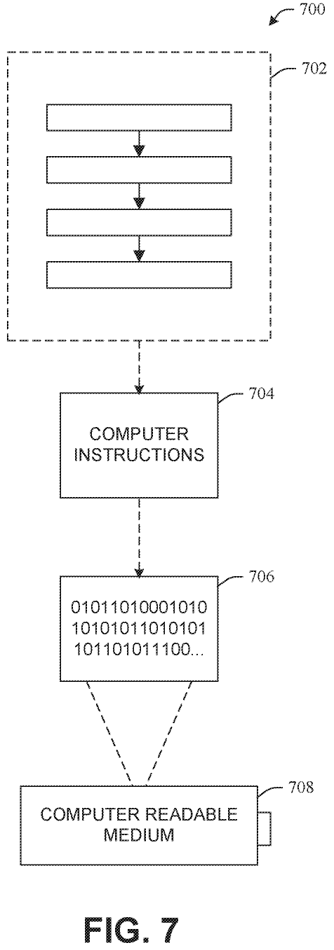

One embodiment of the subject innovation can involve a computer-readable medium comprising processor-executable instructions configured to implement one or more embodiments of the techniques presented herein. An embodiment of a computer-readable storage medium or a computer-readable device that is devised in these ways is illustrated in FIG. 7, wherein an embodiment 700 comprises a computer-readable storage medium 708, such as a CD-R, DVD-R, flash drive, a platter of a hard disk drive, etc., on which is encoded computer-readable data 706. This computer-readable data 706, such as binary data comprising a plurality of zero's and one's as shown in 706, in turn comprises a set of processor executable computer instructions 704 configured to operate according to one or more of the principles set forth herein. In one such embodiment 700, the processor-executable computer instructions 704 is configured to perform a method 702, such as at least a portion of one or more of the methods described in connection with embodiments disclosed herein. In another embodiment, the processor-executable computer instructions 704 are configured to implement a system, such as at least a portion of one or more of the systems described in connection with embodiments disclosed herein. Many such computer-readable media can be devised by those of ordinary skill in the art that are configured to operate in accordance with the techniques presented herein.

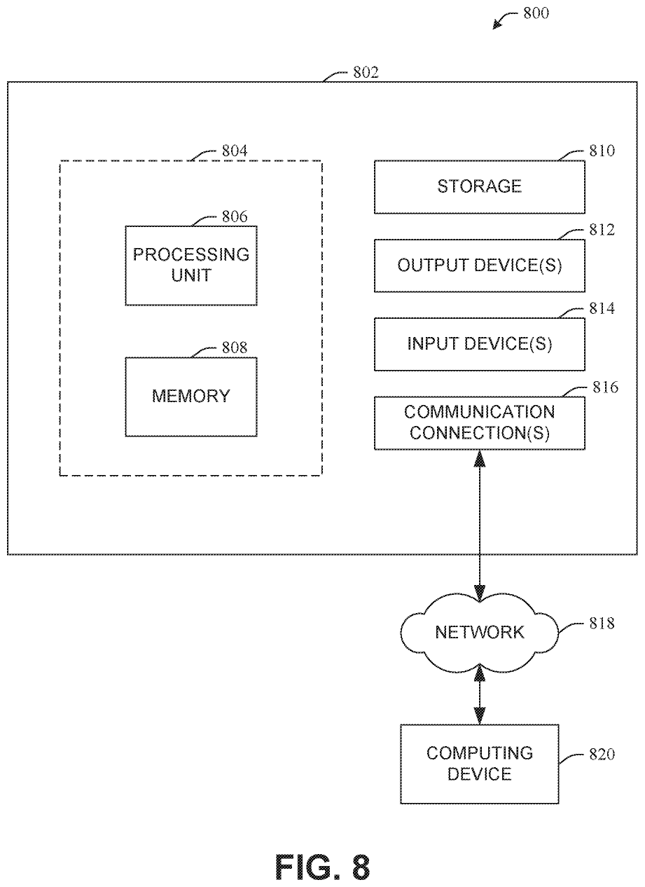

With reference to FIG. 8 and the following discussion provide a description of a suitable computing environment in which embodiments of one or more of the provisions set forth herein can be implemented. The operating environment of FIG. 8 is only one example of a suitable operating environment and is not intended to suggest any limitation as to the scope of use or functionality of the operating environment. Example computing devices include, but are not limited to, personal computers, server computers, hand-held or laptop devices, mobile devices, such as mobile phones, Personal Digital Assistants (PDAs), media players, tablets, and the like, multiprocessor systems, consumer electronics, mini computers, mainframe computers, distributed computing environments that include any of the above systems or devices, and the like.

Generally, embodiments are described in the general context of “computer readable instructions” being executed by one or more computing devices. Computer readable instructions are distributed via computer readable media as will be discussed below. Computer readable instructions can be implemented as program modules, such as functions, objects, Application Programming Interfaces (APIs), data structures, and the like, that perform particular tasks or implement particular abstract data types. Typically, the functionality of the computer readable instructions can be combined or distributed as desired in various environments.

FIG. 8 illustrates a system 800 comprising a device 802 configured to implement one or more embodiments provided herein. In one configuration, the device 802 can include at least one processing unit 806 and memory 808. Depending on the exact configuration and type of computing device, memory 808 may be volatile, such as RAM, non-volatile, such as ROM, flash memory, etc., or some combination of the two. This configuration is illustrated in FIG. 8 by dashed line 804.

In these or other embodiments, device 802 can include additional features or functionality. For example, device 802 can also include additional storage such as removable storage or non-removable storage, including, but not limited to, magnetic storage, optical storage, and the like. Such additional storage is illustrated in FIG. 8 by storage 810. In some embodiments, computer readable instructions to implement one or more embodiments provided herein are in storage 810. Storage 810 can also store other computer readable instructions to implement an operating system, an application program, and the like. Computer readable instructions can be accessed in memory 808 for execution by processing unit 806, for example.

The term “computer readable media” as used herein comprises two distinct and mutually exclusive types, namely computer storage media and communication media. Computer storage media includes storage devices such as memory devices (e.g., random access memory (RAM), read-only memory (ROM), electrically erasable programmable read-only memory (EEPROM) . . . ), magnetic storage devices (e.g., hard drive, floppy disk, tape . . . ) optical disks (e.g., compact disk (CD), digital versatile disk (DVD) . . . ) solid state devices (e.g., solid state drive (SSD), flash memory drive (e.g., card, stick, key drive . . . ) . . . ), or any other like media that store, as opposed to transmit or communicate, desired information accessible by the device 802. Accordingly, computer storage media excludes modulated data signals as well as that described with respect to communication media. The memory 808 and the storage 810 are examples of computer storage media.

Communication media typically embodies computer-executable instructions or data in a “modulated data signal” such as a carrier wave or other transport mechanism and includes any information delivery media. The term “modulated data signal” includes a signal that has one or more of its characteristics set or changed in such a manner as to encode information in the signal. By way of example, and not limitation, communication media includes wired media such as a wired network or direct-wired connection, and wireless media such as acoustic, radio frequency (RF), infrared, and other wireless media.

Device 802 can include one or more input devices 814 such as keyboard, mouse, pen, voice input device, touch input device, infrared cameras, video input devices, or any other input device. One or more output devices 812 such as one or more displays, speakers, printers, or any other output device can also be included in device 802. The one or more input devices 814 and/or one or more output devices 812 can be connected to device 802 via a wired connection, wireless connection, or any combination thereof. In some embodiments, one or more input devices or output devices from another computing device can be used as input device(s) 814 or output device(s) 812 for device 802. Device 802 can also include one or more communication connections 816 that can facilitate communications with one or more other devices 820 by means of a communications network 818, which can be wired, wireless, or any combination thereof, and can include ad hoc networks, intranets, the Internet, or substantially any other communications network that can allow device 802 to communicate with at least one other computing device 820.

What has been described above includes examples of the innovation. It is, of course, not possible to describe every conceivable combination of components or methods for purposes of describing the subject innovation, but one of ordinary skill in the art may recognize that many further combinations and permutations of the innovation are possible. Accordingly, the innovation is intended to embrace all such alterations, modifications and variations that fall within the spirit and scope of the appended claims.

1. A method, comprising:
processing, by a computer system, an employee profile using a machine-learning model to predict an employee status of an employee, wherein the employee status includes a new employee;
determining, by the computer system, that the employee has a rollover-eligible retirement account from a previous employer;
receiving, by the computer system, authorization to receive notifications regarding the rollover-eligible retirement account of the employee;
generating, by the computer system, a notification plan regarding the rollover-eligible retirement account based on the employee status and the authorization;
generating, by the computer system, at least one notification to the employee at a first frequency determined by the notification plan;
receiving, by the computer system, a rollover grievance request from the employee;
in response to receiving the rollover grievance request, registering, by the computer system, a rollover grievance against a previous employer of the employee;
processing, by the computer system, the registered rollover grievance using another machine-learning model to determine a grievance-notification plan;
sending, by the computer system, automated notifications regarding the registered rollover grievance to another computer system associated with the previous employer at a second frequency determined by the grievance-notification plan until the rollover grievance is resolved; and
in response to receiving an indication from the employee that the rollover grievance has been resolved, terminating the sending of the automated notifications to the previous employer.

2. (canceled)

3. The method of claim 1, wherein the at least one notification includes a reminder to rollover a balance of the rollover-eligible retirement account from the previous employer to the rollover-eligible retirement account.

4. (canceled)

5. The method of claim 1, further comprising:
generating and sending, by the computer system, a grievance link to the new employee; and
sending, by the computer system, grievance information regarding the rollover grievance to the previous employer.

6. (canceled)

7. (canceled)

8. The method of claim 1, further comprising:
determining, by the computer system, that the rollover grievance is not resolved within a predetermined period determined by the grievance-notification plan; and
escalating, by the computer system, the rollover grievance for one or more actions according to the grievance-notification plan.

9. The method of claim 8, wherein the escalating includes forwarding the rollover grievance to an external agency to facilitate rollover of the rollover-eligible retirement account.

10. A system, implemented using at least one hardware processor, comprising:
a classification component configured to:
process an employee profile using a machine-learning model to predict an employee status of an employee, wherein the employee status includes a new employee;
determine that the employee has a rollover-eligible retirement account from a previous employer;
an authorization component configured to:
receive authorization to receive notifications regarding the rollover-eligible retirement account of the employee; and
an execution component configured to:
generate a notification plan regarding the rollover-eligible retirement account based on the employee status and the authorization;
generate at least one notification to the employee at a first frequency determined by the notification plan;
receive a rollover grievance request from the employee;
in response to receiving the rollover grievance request, register a rollover grievance against a previous employer of the employee;
process the registered rollover grievance using another machine-learning model to determine a grievance-notification plan;
send automated notifications regarding the registered rollover grievance to another computer system associated with the previous employer at a second frequency determined by the grievance-notification plan until the rollover grievance is resolved; and
in response to receiving an indication from the employee that the rollover grievance has been resolved, terminate the sending of the automated notifications to the previous employer.

11. (canceled)

12. The system of claim 10, wherein the at least one notification includes a reminder to rollover a balance of the rollover-eligible retirement account to the rollover-eligible retirement account.

13. (canceled)

14. The system of claim 10, wherein the execution component is further configured to:
generate and send a grievance link to the new employee; and
send grievance information regarding the rollover grievance to the previous employer.

15. (canceled)

16. (canceled)

17. The system of claim 10, the execution component is further configured to:
determine that the rollover grievance is not resolved within a predetermined period determined by the grievance-notification plan; and
escalate the rollover grievance for one or more actions according to the grievance-notification plan.

18. The system of claim 17, wherein the execution component is further configured to:
forward the rollover grievance to an external agency to facilitate rollover of the rollover-eligible retirement account.

19. A non-transitory computer-readable storage medium having instructions stored thereon that when executed by one or more processors control the one or more processors to:
process an employee profile using a machine-learning model to predict an employee status of an employee, wherein the employee status includes a new employee;
determine that the employee has a rollover-eligible retirement account from a previous employer;
receive authorization to receive notifications regarding the rollover-eligible retirement account of the employee;
generate a notification plan regarding the rollover-eligible retirement account based on the employee status and the authorization;
generate at least one notification to the employee at a first frequency determined by the notification plan;
receive a rollover grievance request from the employee;
in response to receiving the rollover grievance request, register the rollover grievance against a previous employer of the employee;
process the registered rollover grievance using another machine-learning model to determine a grievance-notification plan;
send automated notifications regarding the registered rollover grievance to another computer system associated with the previous employer at a second frequency determined by the grievance-notification plan until the rollover grievance is resolved; and
in response to receiving an indication from the employee that the rollover grievance has been resolved, terminating the sending of the automated notifications to the previous employer.

20. The non-transitory computer-readable storage medium of claim 19, wherein the one or more processors are further configured to:
determine that the rollover grievance is not resolved within a predetermined period determined by the grievance-notification plan; and
escalate an unsolved grievance to an external party.
